(19) United States
(12) Patent Application Publication
(10) Pub. No.: US 2019/0259250 A1
(43) Pub. Date: Aug. 22, 2019

(54) SYSTEMS, APPARATUSES AND METHODS FOR COMPLETING POKER HANDS BASED ON ACTIVITIES IN OTHER POKER HANDS

(71) Applicant: KING SHOW GAMES, INC., Minnetonka, MN (US)

(72) Inventor: Bradley BERMAN, Minnetonka, MN (US)

(21) Appl. No.: 16/280,188

(22) Filed: Feb. 20, 2019

Related U.S. Application Data
(60) Provisional application No. 62/632,521, filed on Feb. 20, 2018.

(51) Int. Cl. G07F 17/32

(52) U.S. Cl. CPC G07F 17/3293; G07F 17/3262; G07F 17/3211

(57) ABSTRACT

Systems, apparatuses and methods for allowing one or more draw poker hands in a multiple-hand poker game to receive the benefit of a favorable draw of replacement cards in one or more other of the draw poker hands. One embodiment involves replicating held cards from a first played draw poker hand to one or more additional draw poker hands, providing replacement cards for non-held/discarded cards from the first played hand, and replicating the replacement cards from the first played hand into the additional draw poker hands if the replacement cards meet certain criteria or at least contribute to meeting certain criteria.

### FIELD

This disclosure relates generally to games, and more particularly to systems, apparatuses and methods for completing poker hands based on activities in other poker hands.

### BACKGROUND

Casino games such as poker, slots, and craps have long been enjoyed as a means of entertainment. Some of these games originated using traditional elements such as playing cards or dice. More recently, gaming devices have been developed to simulate and/or further enhance these games while remaining entertaining. The popularity of casino gambling with wagering continues to increase, as does recreational gambling such as non-wagering computer game gambling. Part of this popularity is due to the increased development of new types of games that are implemented, at least in part, on gaming devices.

One reason that casino games are widely developed for gaming devices is that a wide variety of games can be implemented on gaming devices, thereby providing an array of choices for players looking to gamble. For example, the graphics and sounds included in such games can be modified to reflect popular subjects, such as movies and television shows. Game play rules and types of games can also vary greatly providing many different styles of gambling. Additionally, gaming devices require minimal supervision to operate on a casino floor, or in other gambling environments. That is, as compared to traditional casino games that require a dealer, banker, stickman, pit managers, etc., gaming devices need much less employee attention to operate.

With the ability to provide new content, players have come to expect the availability of an ever wider selection of new games when visiting casinos and other gaming venues. Playing new games adds to the excitement of “gaming.” As is well known in the art and as used herein, the term “gaming” and “gaming devices” generally involves some form of wagering, and that players make wagers of value, whether actual currency or something else of value, e.g., token or credit. Wagering-type games usually provide rewards based on random chance as opposed to skill, although some skill may be an element in some types of games. Since random chance is a significant component of these games, they are sometimes referred to as “games of chance.”

The present disclosure describes systems, apparatuses and methods that facilitate new and interesting gaming experiences, and provide advantages over the prior art.

### SUMMARY

The present disclosure is directed to systems, apparatuses, computer-readable media, and/or methods that are configured to allow one or more draw poker hands in a multiple-hand poker game to receive the benefit of a favorable draw in one or more other of the draw poker hands. In other embodiments, the favorable draw instead or additionally creates payout modifiers or other enhancements that may be applied against hands in the multiple-hand poker game.

In accordance with one embodiment, an apparatus is provided for enhancing payouts in a multi-hand electronic poker event. The apparatus includes a display that presents the multi-hand electronic poker event and an associated plurality of poker hands. A user interface includes at least one user input to enable the player to initiate the multi-hand electronic poker event. A wager input device is structured to identify and validate player assets, and to permit the player to play the multi-hand electronic poker event when the player assets are provided. A processor is configured to deal the poker hands, and reveal cards of at least the first poker hand. The processor is further configured to facilitate holding any number of the cards of the first poker hand, and to facilitate discarding those cards of the first poker hand that were not held. The processor is further configured to replicate the cards held in the first poker hand into the remaining poker hands, provide replacement cards for the cards that were not held in the first poker hand, determine whether the replacement cards provided in the first hand meet a condition, and to replicate the replacement cards into one or more of the remaining ones of the plurality of poker hands if the condition is met.

In a more particular embodiment of such an apparatus, the processor is configured to replicate the replacement cards into all of the remaining poker hands in response to the condition being met.

In another embodiment of such an apparatus, the processor is configured to determine whether the first hand's replacement cards meet the condition by determining whether the replacement cards cause a result of the first hand to reach a threshold poker hand value. For example, the condition may be that those cards required to provide the highest ranking result possible in view of the cards held in the first poker hand, whereby the processor is configured to determine whether the first hand's replacement cards hand correspond to the cards required to provide the highest ranking result possible. In another example, the processor may be configured to determine whether the replacement cards cause the result of the first hand to reach the threshold poker hand value by determining whether the result of the first hand includes a predetermined number of like card values. In still another example, the processor may be configured to determine whether the replacement cards cause the result of the first hand to reach the threshold poker hand value by determining whether the result of the first hand includes a consecutive string of card values and/or includes all cards having a common suit. In one embodiment, the processor is configured to determine whether the result of the first hand reaches the threshold poker value by comparing the result of the first hand to one or more predetermined poker hand values that meet or exceed the threshold poker hand value.

In another embodiment of such an apparatus, the processor is configured to determine whether the first hand's replacement cards themselves meet a condition, such as by comparing the replacement cards to a plurality of predetermined poker values that meet or exceed threshold card values.

In another embodiment, a gaming device is provided that includes at least a display, a user interface, a wager input device, and a processor. The display presents a poker event involving multiple concurrently-played poker hands presented in a sequence ranging from a first poker hand to a last poker hand. The user interface includes at least one user input to enable a player to initiate play in the poker event. The wager input device is structured to identify and validate player assets, and to permit the player to play the poker event when the player assets are provided. The processor is configured to deal the concurrently-played poker hands and reveal cards of at least a first one of the poker hands, facilitate holding any number of the cards of the first poker hand and discarding those cards of the first poker hand that were not held, and replicate the cards held in the first poker hand into the remaining poker hands in the sequence through the last poker hand. The processor is configured to provide unique replacement cards for the first poker hand and each of the remaining poker hands along the sequence, until it is determined that a resulting poker hand value for one of the poker hands along the sequence meets a poker outcome condition, in which case the unique replacement cards from the poker hand that met the poker outcome condition are replicated into subsequent poker hands of the sequence.

In a more particular embodiment of such a gaming device, the processor is further configured to replicate the unique replacement cards, from the poker hand that met the poker outcome condition, into prior poker hands of the sequence, before the resulting poker hand values for those prior poker hands of the sequence are established for win analysis. In an alternative embodiment, the processor is configured to replicate the unique replacement cards, from the poker hand that met the poker outcome condition, into prior poker hands of the sequence, after the resulting poker hand values for those prior poker hands of the sequence have already been established for win analysis to provide for a second win analysis.

In one embodiment of such a gaming device, the poker hand along the sequence that meets the poker outcome condition is any of the poker hands in the sequence.

In another embodiment of the gaming device, the processor is further configured to apply a payout modifier to the resulting poker hand value for the poker hand that met the poker outcome condition. In one embodiment, the processor is still further configured to establish a value of the payout modifier based at least in part upon which poker hand in the sequence the poker outcome condition was met. In still another embodiment, the processor is configured to establish the value of the payout modifier to be higher the earlier in the sequence that the poker outcome condition was met.

In still another embodiment of such a gaming device, the processor is further configured to apply the payout modifier to the resulting poker hand values for the subsequent poker hands of the sequence.

In another embodiment, a gaming device is provided that includes a display to present a poker event that includes multiple poker hands arranged (e.g., physically, logically, numbered, etc.) in a sequence beginning with a first poker hand. A user interface includes a user input(s) to enable a player to initiate and participate in the poker event. A wager input device is structured to identify and validate player assets, and to permit the player to participate in the poker event when the player assets are provided. A processor (including any one or more local or distributed processing units, or any processing arrangement) is configured to deal the multiple poker hands, and to reveal cards of at least the first poker hand in the sequence. The processor facilitates holding (e.g., by player, or automatically based on rules, or randomly, etc.) of any number of the cards of the first poker hand, discarding of those cards of the first poker hand that were not held, and replicating the cards held in the first poker hand into the remaining poker hands of the sequence. The processor is further configured to provide first replacement cards for the first poker hand, and to determine whether a poker outcome of the first poker hand reaches a threshold poker value as a result of the first replacement cards. If so, in one embodiment, the first replacement cards are replicated into all subsequent ones of the plurality of poker hands in the sequence (where in other embodiments the first replacement cards are replicated into some subset of the poker hands of the sequence). If the first replacement cards of the first poker hand did not reach the threshold poker value, new replacement cards are provided for the next one of the poker hands in the sequence.

In a more particular embodiment of such a gaming device, the processor is configured to determine the best poker hand possible given the cards held in the first poker hand, and to set the threshold poker value to that best poker hand possible for the poker event.

In another embodiment, a method is provided for concurrently playing multiple poker hands. The representative method includes dealing a plurality of poker hands, and revealing cards of at least a first poker hand, enabling the holding any number of the cards of the first poker hand and discarding those cards of the first poker hand that were not held, replicating the cards held in the first poker hand into the remaining poker hands, providing replacement cards for the first poker hand, determining whether the replacement cards meet or exceed a threshold poker value, and providing a payout modifier for at least one of the remaining ones of the plurality of poker hands if the replacement cards meet or exceed the threshold poker value. In yet another embodiment, a method is provided for concurrently playing multiple poker hands. The representative method includes dealing multiple poker hands, and revealing cards of at least a first one of the poker hands. The method further includes facilitating holding any number of the cards of the first poker hand, discarding those cards of the first poker hand that were not held, replicating the cards held in the first poker hand into the remaining poker hands, and providing replacement cards for the first poker hand. The method further involves determining whether a final poker hand value of the first poker hand, based on the held cards and the replacement cards, meets or exceeds a threshold poker value, and providing a payout modifier for at least one of the remaining ones of the poker hands if the final poker hand value of the first poker hand meets or exceeds a threshold poker value.

This summary serves as an abbreviated, selective introduction of a representative subset of various concepts and embodiments that are further described or taught to those skilled in the art in the Specification herein. This summary is not intended to refer to all embodiments, scopes, or breadths of claims otherwise supported by the Specification, nor to identify essential features of the claimed subject matter, nor to limit the scope of the claimed subject matter.

### BRIEF DESCRIPTION OF THE DRAWINGS

FIG. 1 is a diagram of a representative gaming machine capable of facilitating player use and interaction with games and features in accordance with the invention and representative embodiments described herein.

FIG. 2 is a block diagram illustrating a representative computing arrangement capable of implementing games and features in accordance with the invention and representative embodiments described herein.

FIG. 3 is a block diagram illustrating a representative manner of completing one or more poker hands by replicating qualifying draw card sets occurring in at least one other poker hand in a multi-hand poker context.

FIG. 4A depicts representative final poker hand values that may be used as qualifying criteria for one or more other poker hands to receive and use the same draw/replacement cards that benefited the source/first poker hand(s) such that it reached the particular final poker hand value.

FIG. 4B depicts representative replacement card poker ranks that may be used as qualifying criteria for one or more other poker hands to receive and use the same replacement cards that were drawn in the source/first poker hand(s).

FIGS. 4C-4F depict representative examples of using context-specific criteria to trigger replication of replacement cards from at least one hand into at least one other hand.

FIG. 5 depicts a representative example of a multi-hand draw poker game implementing an embodiment of a criteria-based draw card replication as disclosed herein.

FIG. 6 depicts an example of a multi-play poker game where replacement cards meeting certain criteria are allowed for use in hands subsequent to the hand meeting the criteria in the sequence.

FIG. 7 depicts an example where a payout modifier, such as a multiplier, is provided for hands subsequent to the hand having drawn cards triggering the feature.

FIG. 8 is a block diagram of a representative gaming apparatus for completing poker hands based on activities in other poker hands.

### DETAILED DESCRIPTION

In the following description of various exemplary embodiments, reference is made to the accompanying drawings which form a part hereof, and in which is shown by way of illustration representative embodiments in which the features described herein may be practiced. It is to be understood that other embodiments may be utilized, as structural and operational changes may be made without departing from the scope of the disclosure.

In the description that follows, the terms “reels,” “cards,” “decks,” and similar mechanically descriptive language may be used to describe various apparatus presentation features, as well as various actions occurring to those objects (e.g., “spin,” “draw,” “hold,” “bet”). Although the present disclosure may be applicable to manual, mechanical, and/or computerized embodiments, as well as any combination therebetween, the use of mechanically descriptive terms is not meant to be only applicable to mechanical embodiments. Those skilled in the art will understand that, for purposes of providing gaming experiences to players, mechanical elements such as cards, reels, and the like may be simulated on a display in order to provide a familiar and satisfying experience that emulates the behavior of mechanical objects, as well as emulating actions that occur in the non-computerized games (e.g., spinning, holding, drawing, betting). Further, the computerized version may provide the look of mechanical equivalents but may be generally randomized in a different way. Thus, the terms “cards,” “decks,” “reels,” “hands,” etc., are intended to describe both physical objects and emulation or simulations of those objects and their behaviors using electronic apparatuses.

In various embodiments, the gaming displays are described in conjunction with the use of data in the form of “symbols.” In the context of this disclosure, a “symbol” may generally refer at least to a collection of one or more arbitrary indicia or signs that have some conventional or defined significance. In particular, the symbol may represent values that can at least be used to determine whether to award a payout. A symbol may include numbers, letters, shapes, pictures, textures, colors, sounds, etc., and any combination therebetween. A play state, such as a win, can be determined by comparing the symbol with one or more other symbols. Such comparisons can be performed, for example, via software by mapping numbers (or other data structures such as character strings) to the symbols and performing the comparisons on the numbers/data structures. Other conventions associated with known games (e.g., the numerical value/ordering of face cards and aces in card games) may also be programmatically analyzed to determine winning combinations.

Generally, systems, apparatuses and methods are described for providing high-value replacement cards in draw-based poker games by overriding random replacement cards in one or more poker hands with high-value replacement cards from another poker hand(s). For example, in a multi-hand/multi-play poker environment, multiple starting hands of poker are dealt, and cards that are held in at least one starting hand can be replicated into one or more of the other starting hands. In such a poker environment, the present disclosure describes manners in which drawn cards (i.e. those not held) can be replicated into one or more other poker hands. Whether drawn cards are replicated into one or more (or all) other hands may be dependent on, for example, the “value” of the drawn cards into a first/original one of the hands, whether the “value” of the replacement cards independently meet some criteria (e.g., same suit, same value, form a portion of a straight, etc.), whether a final result of a first/original one of the hands meets a paytable threshold (e.g., flush or above), or the like. In other embodiments the drawn hands into a first/original one of the hands may be replicated when the drawn hands have a top value—i.e. was the perfect draw for the held cards in the first/original hand.

In another embodiment, hands concurrently played may replicate draw cards from at least a first/original hand, without having held cards replicated. For example, a first hand may hold two cards and draw three cards, where the three drawn cards meet criteria to allow those drawn cards to be replicated into other hands where three (or more) replacement cards are needed. For example, if three Aces were drawn in the first/original hand to replace three discarded cards, that may meet criteria to have those cards replicated into the other hands requiring three or more replacement (i.e. non-held) cards.

Thus, in some embodiments, if a player obtains a perfect or sufficiently high (e.g., above a threshold value) draw in a first poker hand, the drawn cards are replicated into the draw spots of other multi-play poker hands. These and other embodiments are described below.

The systems, apparatuses and methods described herein may be implemented as a single game, or part of a multi-part game. For example, the game features described herein may be implemented in primary gaming activities, bonus games, side bet games or other secondary games associated with a primary gaming activity. The game features may be implemented in stand-alone games, multi-player games, etc. Further, the disclosure may be applied to games of chance, and descriptions provided in the context of any representative game (e.g. poker, such as video poker) is provided for purposes of facilitating an understanding of the features described herein. However, the principles described herein are equally applicable to any game of chance where an outcome(s) is determined for use in the player's gaming activity.

Embodiments of the present concept include providing gaming devices (also referred to as gaming apparatuses or gaming machines), gaming systems, and methods of operating these devices or systems to provide game play that involves of allow one or more draw poker hands in a multiple-hand poker game to receive the benefit of a favorable draw in one or more other of the draw poker hands.

Numerous variations are possible in view of these and other embodiments of the inventive concept. Representative embodiments and variations are described herein, with some embodiments described with reference to the drawings. However, many other embodiments and variations exist that are covered by the principles and scope of this concept. For example, although some of the embodiments discussed below involve reel-based slot machine examples of this concept, other embodiments include application of these inventive techniques in other types of slot games, poker games, or other games of chance. Some of these other types of embodiments will be discussed below as variations to the examples illustrated. However, many other types of games can implement similar techniques and fall within the scope of this disclosed concept.

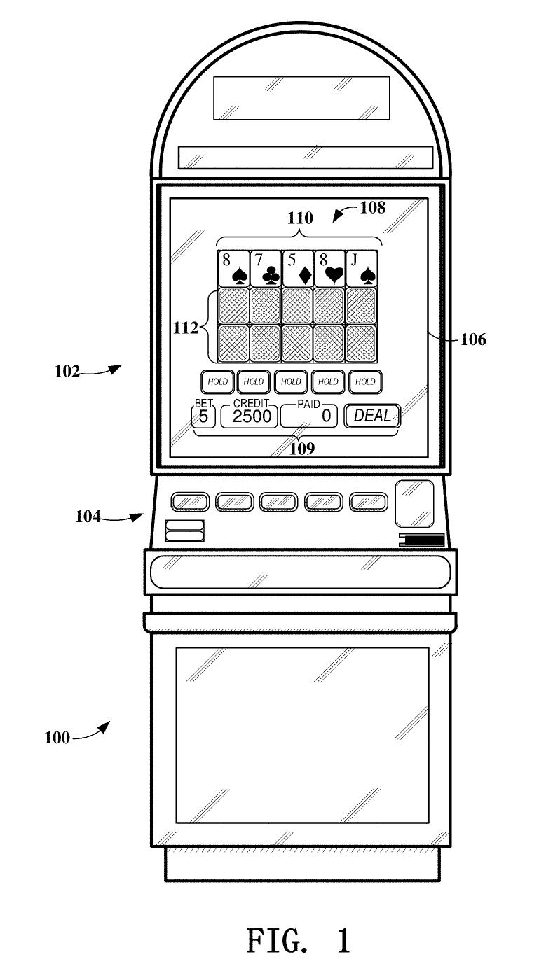

Referring to the example gaming apparatus 100 shown in FIG. 1, the representative gaming apparatus includes at least a display area(s) 102 (also referred to as a gaming display), and a player interface area(s) 104, although some or all of the interactive mechanisms included in the user interface area 104 may be provided via other or additional means, such as graphical icons used with a touch screen in the display area 102 in some embodiments. The display area 102 may include one or more game displays 106 (also referred to as “displays” or “gaming displays”) that may be included in physically separate displays or as portions of a common large display. Here, the representative game display 106 includes at least a primary game play portion 108 that displays game elements and symbols 110, and an operations portion 109 that can include meters, various game buttons and other input mechanisms, and/or other game information for a player of the gaming device 100.

The user interface 104 allows the user to control, engage in play of, and otherwise interact with the gaming machine 100. The particular user interface mechanisms included with user interface 104 may be dependent on the type of gaming device. For example, the user interface 104 may include one or more buttons, switches, joysticks, levers, pull-down handles, trackballs, voice-activated input, touchscreen input, tactile input, and/or any other user input system or mechanism that allows the user to play and interact with the particular gaming activity.

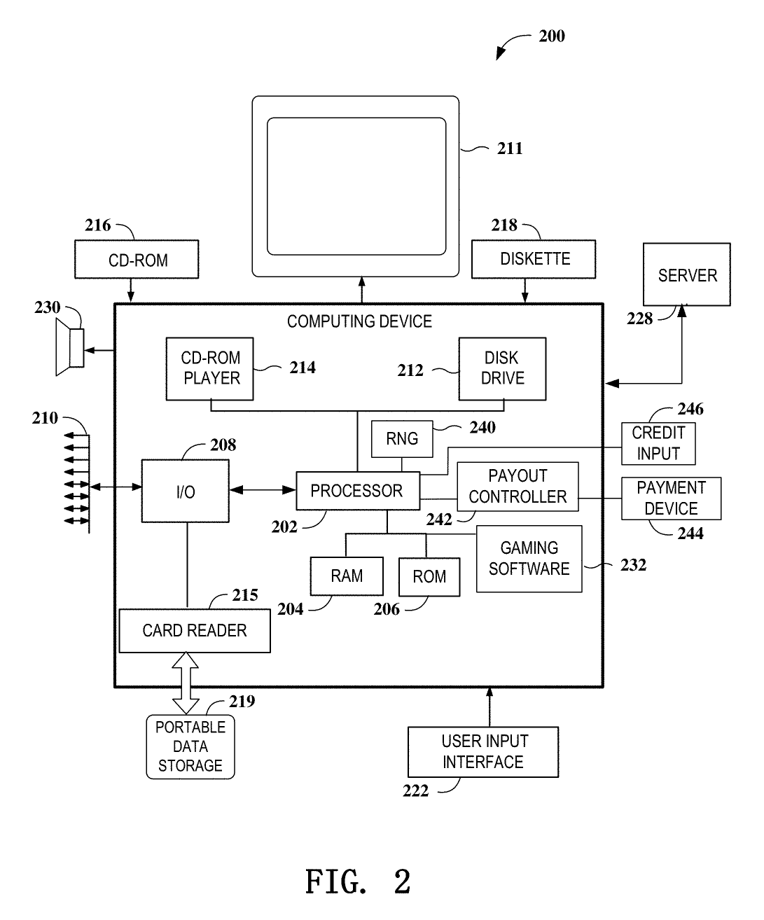

The user interface 104 may allow the user or player to enter coins, bills, or otherwise obtain credits through vouchers, tokens, credit cards, tickets, electronic money, etc. Various mechanisms for entering such vouchers, tokens, credit cards, coins, tickets, etc. are described below with reference to FIG. 2. For example, currency input mechanisms, card readers, credit card readers, smart card readers, punch card readers, radio frequency identifier (RFID) readers, and other mechanisms may be used to enter wagers. The user interface 104 may also include a mechanism to read and/or validate player information, such as player loyalty information to identify a user or player of the gaming device. This mechanism may be, for example, a card reader, biometric scanner, keypad, or other input device. It is through a user interface such as the user interface 104 that the player can initiate and engage in gaming activities. While the illustrated embodiment depicts various buttons for the user interface 104, it should be recognized that a wide variety of user interface options are available for use in connection with the present invention, including pressing buttons, touching a segment of a touch-screen, entering text, entering voice commands, or other known data entry methodology.

The game display 106 in the display area 102 may include one or more of an electronic display, a video display, a mechanical display, and fixed display information, such as pay table information associated with a glass/plastic panel(s) on the gaming machine 100 and/or graphical images. The symbols or other indicia associated with the play of the game may be presented on an electronic display device or on mechanical devices associated with a mechanical display. Generally, in some embodiments, the display 106 devotes the largest portion of viewable area to the primary gaming portion 108. The primary gaming portion 108 may provide visual feedback to the user for any selected game. The primary gaming portion 108 may render graphical objects such as cards, slot reels, dice, animated characters, and any other gaming visual known in the art. The primary gaming portion 108 may also inform players of the outcome of any particular event, including whether the event resulted in a win or loss.

In some embodiments described herein, the primary gaming portion 108 may display a grid(s) or equivalent arrangement(s) of playing cards 110 forming one or more hands or other sets of cards in a card game, such as a poker game. In the illustrated example, a set of five playing cards 110 forms a video poker hand, which represents a portion of a game play event. For example, if the game play event is a video draw poker game, the gaming device 100 may deal five cards, allow the user to select cards to hold, deal replacements for the cards not held, and determine a payout based on the final cards in the hand. The illustration and description of five-card draw poker is for purposes of example and not of limitation, as the disclosure is applicable to numerous other card games, such as stud poker or hold'em poker, as well as other types of gaming activities and apparatuses, such as slot machines, dice, coins, etc. For example, some embodiments may relate to slot games, where the primary gaming portion 108 presents a grid (or equivalent arrangement) of symbols or other game elements in respective symbol locations (not shown), where the symbols or combinations of symbols determine gaming outcomes.

The primary gaming portion 108 may include other features known in the art that facilitate gaming, such as status and control portion 109. As is generally known in the art, this portion 109 provides information about current bets, current wins, remaining credits, etc. associated with gaming activities of the grid of game elements 110. The control portion 109 may also provide touchscreen controls for facilitating game play. The grid of game elements 110 may also include touchscreen features, such as facilitating selection of individual cards to hold and/or selection of individual cards to discard and replace (e.g., in a draw poker embodiment), which subset of cards of a larger set of cards to hold/use for a final hand(s) (e.g., in some stud poker embodiments), wagering inputs, etc. The game display 106 of the display area 102 may include other features that are not shown, such as pay tables, navigation controls, etc.

Although FIG. 1 illustrates a particular implementation of some of the embodiments in a casino or electronic gaming machine (“EGM”), one or more devices may be programmed to play various embodiments of the disclosure. The concepts and embodiments described herein may be implemented, as shown in FIG. 1, as an electronic/video gaming machine or other special purpose gaming kiosk, or may be implemented via computing systems operating under the direction of local gaming software, and/or remotely-provided software such as provided by an application service provider (ASP). Such gaming machines may also utilize computing systems to control and manage the gaming activity, although these computing systems typically include specialized components and/or functionality to operate the particular elements of electronic gaming machines. Additionally, computing systems operating over networks, such as the Internet, may also include specialized components and/or functionality to operate elements particular to these systems, such as random number generators. An example of a representative computing system capable of carrying out operations in accordance with the principles described herein is illustrated in FIG. 2.

Hardware, firmware, software or any combination thereof may be used to perform the various gaming functions, display presentations and operations described herein. The functional modules used in connection with the disclosure may reside in a gaming machine as described, or may alternatively reside on a stand-alone or networked computer. The representative computing structure 200 of FIG. 2 is an example of a computing structure that can be used in connection with such electronic gaming machines, computers, or other computer-implemented devices to carry out operations of the present invention. Although numerous components or elements are shown as part of this computing structure 200 in FIG. 2, additional or fewer components may be utilized in particular implementations of embodiments of the invention.

The example computing arrangement 200 suitable for performing the gaming functions described herein includes a processor(s), such as depicted by the representative central processing unit (CPU) 202, coupled to memory, such as random access memory (RAM) 204, and some variation of read-only memory (ROM) 206 or other persistent storage. The ROM 206 may also represent other types of storage media to store programs, such as programmable ROM (PROM), erasable PROM (EPROM or any technology capable of storing data). The processor 202 may communicate with other internal and external components through input/output (I/O) circuitry 208 and bussing 210, to communicate control signals, communication signals, and the like.

The computing arrangement 200 may also include one or more data storage devices, including hard and floppy disk drives 212, CD-ROM drives 214, card reader 215, and other hardware capable of reading and/or storing information such as DVD, etc. In one embodiment, software for carrying out the operations in accordance with the present invention may be stored and distributed on a CD-ROM 216, diskette 218, access card 219, or other form of computer readable media capable of portably storing information. These storage media may be inserted into, and read by, devices such as the CD-ROM drive 214, the disk drive 212, card reader 215, etc. The software may also be transmitted to the computing arrangement 200 via data signals, such as being downloaded electronically via a network, such as local area network (casino, property, or bank network) or a wide area network (e.g., the Internet). Further, as previously described, the software for carrying out the functions associated with the present invention may alternatively be stored in internal memory/storage of the computing device 200, such as in the ROM 206.

The computing arrangement 200 is coupled to one or more displays 211, which represent a manner in which the gaming activities may be presented. The display 211 represents the “presentation” of the game information in accordance with the disclosure, and may be a mechanical display, or an electronic/video display such as liquid crystal displays, plasma displays, cathode ray tubes (CRT), digital light processing (DLP) displays, liquid crystal on silicon (LCOS) displays, etc., or any type of known display or presentation screen.

Where the computing device 200 represents a stand-alone or networked computer, the display 211 may represent a standard computer terminal or display capable of displaying multiple windows, frames, etc. Where the computing device 200 represents a mobile electronic device, the display 211 may represent the video display of the mobile electronic device. Where the computing device 200 is embedded within an electronic gaming machine, the display 211 corresponds to the display screen of the gaming machine/kiosk.

A user input interface 222 such as a mouse, keyboard/keypad, microphone, touch pad, trackball, joystick, touch screen, voice-recognition system, card reader, biometric scanner, RFID detector, etc. may be provided. The user input interface 222 may be used to input commands in the computing arrangement 200, such as placing wagers or initiating gaming events on the computing arrangement 200, inputting currency or other payment information to establish a credit amount or wager amount, inputting data to identify a player for a player loyalty system, etc. The display 211 may also act as a user input device, e.g., where the display 211 is a touchscreen device. In embodiments, where the computing device 200 is implemented in a personal computer, tablet, smart phone, or other consumer electronic device, the user interface and display may be the available input/output mechanisms related to those devices.

Chance-based gaming systems such as slot machines, in which the present invention is applicable, are governed by random numbers and processors, as facilitated by a random number generator (RNG) or other random generator. The fixed and dynamic symbols generated as part of a gaming activity may be produced using one or more RNGs. RNGs may be implemented using hardware, software operable in connection with the processor 202, or some combination of hardware and software. The principles described herein are operable using any known RNG, and may be integrally programmed as part of the processor 202 operation, or alternatively may be a separate RNG controller 240 that may be associated with the computing arrangement 200 or otherwise accessible such as via a network. The RNGs are often protected by one or more security measures to prevent tampering, such as by using secured circuitry, locks on the physical game cabinet, and/or remote circuitry that transmits data to the gaming device.

The computing arrangement 200 may be connected to other computing devices or gaming machines, such as via a network. The computing arrangement 200 may be connected to a network server(s) 228 in an intranet or local network configuration. The computer may further be part of a larger network configuration as in a global area network (GAN) such as the Internet. In such a case, the computer may have access to one or more web servers via the Internet. In other arrangements, the computing arrangement 200 may be configured as an Internet server and software for carrying out the operations in accordance with the present invention may interact with the player via one or more networks. The computing arrangement 200 may also be operable over a social network or other network environment that may or may not regulate the wagering and/or gaming activity associated with gaming events played on the computing arrangement.

Other components directed to gaming machine implementations include manners of gaming participant payment, and gaming machine payout. For example, a gaming machine including the computing arrangement 200 may also include a payout controller 242 to receive a signal from the processor 202 or other processor(s) indicating a payout is to made to a player and controlling a payout device 244 to facilitate payment of the payout to the player. In some embodiments, the payout controller 242 may independently determine the amount of payout to be provided to the participant or player. In other embodiments, the payout controller 242 may be integrally implemented with the processor 202. The payout controller 242 may be a hopper controller, a print driver, credit-transmitting device, bill-dispensing controller, accounting software, or other controller device configured to verify and/or facilitate payment to a player.

A payout or payment device 244 may also be provided in gaming machine embodiments, where the payment device 244 serves as the mechanism providing the payout to the player or participant. In some embodiments, the payment device 244 may be a hopper, where the hopper serves as the mechanism holding the coins/tokens of the machine, and/or distributing the coins/tokens to the player in response to a signal from the payout controller 242. In other embodiments, the payout device 244 may be a printer mechanism structured to print credit-based tickets that may be redeemed by the player for cash, credit, or other casino value-based currency or asset. In yet other embodiments, the payout device 244 may send a signal via the network server 228 or other device to electronically provide a credit amount to an account associated with the player, such as a credit card account or player loyalty account. The computing arrangement 200 may also include accounting data stored in, for example, one of the memory devices 204, 206. This accounting data may be transmitted to a casino accounting network or other network to manage accounting statistics for the computing arrangement or to provide verification data for the currency or currency-based tickets distributed by the payout device, such as providing the data associated with the bar codes printed on the currency-based tickets so they are identifiable as valid tickets for a particular amount when the player redeems them or inserts them in another gaming device.

The wager input module or device 246 represents any mechanism for accepting coins, tokens, coupons, bills, electronic fund transfer (EFT), tickets, credit cards, smart cards, membership/loyalty cards, or any other player assets, for which a participant inputs a wager amount. The wager input device 246 may include magnetic strip readers, bar code scanners, light sensors, or other detection devices to identify and validate physical currency, currency-based tickets, cards with magnetized-strips, or other medium inputted into the wager input device. When a particular medium is received in the wager input device 246, a signal may be generated to establish or increase an available credit amount or balance stored in the internal memory/storage of the computing device 200, such as in the RAM 204. Thereafter, specific wagers placed on games may reduce the available credit amount, while awards won may increase the available credit amount. It will be appreciated that the primary gaming software 232 may be able to control payouts via the payment device 244 and payout controller 242 for independently determined payout events.

Among other functions, the computing arrangement 200 provides an interactive experience to players via an input interface 222 and output devices, such as the display 211, speaker 230, etc. These experiences are generally controlled by gaming software 232 that controls a primary gaming activity of the computing arrangement 200. The gaming software 232 may be temporarily loaded into RAM 204, and may be stored locally using any combination of ROM 206, drives 212, media player 214, or other computer-readable storage media known in the art. The primary gaming software 232 may also be accessed remotely, such as via the server 228 or the Internet.

The primary gaming software 232 in the computing arrangement 200 may be an application software module. According to embodiments of the present invention, this software 232 provides a slot game or similar game of chance as described herein. For example, the software 232 may present, by way of the display 211, representations of symbols to map or otherwise display as part of a slot based game having reels. However, in other embodiments, the principles of this concept may be applied to poker games or other types of games of chance. One or more aligned positions of these game elements may be evaluated to determine awards based on a pay table. The software 232 may include instructions to provide other functionality as known in the art or as described and shown herein.

The systems, apparatuses and methods operable via these and analogous computing and gaming devices can support gaming features as described herein. In one embodiment, one or more concurrently-played draw poker hands are allowed, when a threshold or other criteria is met, to utilize the same draw/replacement cards that another poker hand drew as replacement cards. The criteria may be, for example, some threshold that causes the source draw poker hand to have a favorable result, such as the best result possible in view of its held cards, a final hand poker rank at or above some predetermined or dynamically or randomly selected threshold, etc. In this manner, other hands in a multiple-hand draw poker environment, such as in an embodiment where the held cards from a source/first hand were also replicated into the other poker hands, will equally benefit from the favorable draw of replacement cards into the source/first poker hand played.

Many embodiments may be described in terms of an electronic poker game, where presented cards potentially form a result(s) that conforms to a predetermined winning outcome to determine payout awards. However, the principles described herein are equally applicable to other games of chance, as described herein and as will be readily apparent to those skilled in the art from the teachings herein.

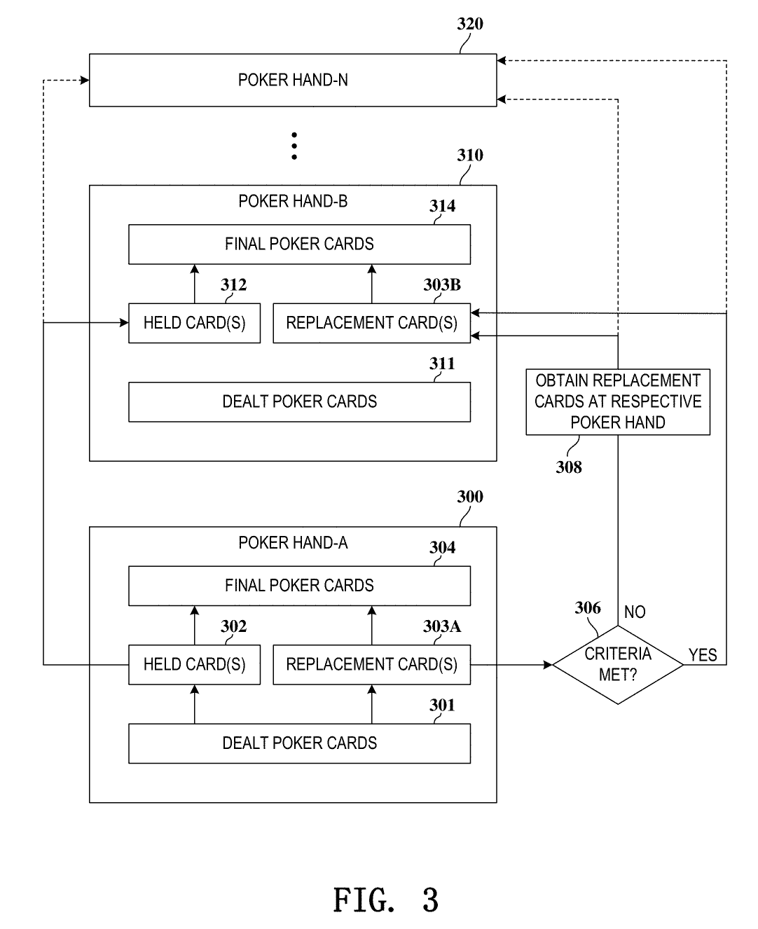

FIG. 3 is described in the context of such a video/electronic poker game embodiment, although the principles are also applicable in other embodiments such as in a physical poker context. This embodiment depicts a block diagram illustrating a manner of completing one or more poker hands by replicating qualifying draw card sets occurring in at least one other poker hand in a multi-hand poker context. A multi-hand or multi-play context as used herein refers to a plurality of poker hands played concurrently, where cards held in at least one hand are replicated as held cards into one or more of the other concurrently-played hands.

It should be noted that other multiple-hand embodiments may involve concurrently-played poker hands, without the replication of a first hand(s) held cards to serve as one or more other hand's held cards. In other words, other multiple-hand embodiments that are not “multi-play” as used herein may be used in connection with the teachings of the present disclosure, as the held cards would not have to be replicated. But in such embodiments, other considerations may be accounted for, such as replicating those hands having a similar characteristic(s) to the first hand, such as same number of draw cards needed, suit of held cards, card value of held cards, consecutive nature of held cards, and/or any combination thereof, and/or other desired card or hand characteristics. In any event, for purposes of illustration and example, the embodiment of FIG. 3 is described in the context of a multi-play embodiment where held cards are replicated into other hands.

In the example of FIG. 3, a first poker hand, depicted as poker hand-A 300, represents a draw poker play/hand involving initially dealt cards 301, zero, one or more held cards 302 from the initially dealt cards 301, potentially one or more replacement cards 303A representing cards replaced from the poker card deck(s) that were provided as a result of any initially dealt cards 301 being discarded, and final poker cards 304 representing those held cards 302 and replacement cards 303A. The example of FIG. 3 is described in terms of a multi-play poker game, where cards that are held in a poker hand, e.g., poker hand-A 300, may be replicated into concurrently-played hands poker hand-B 310, and possibly more up to an indeterminate number of poker hands represented by poker hand-N 320. However, the principles described in this example (and other examples) are also applicable to other concurrently-played draw poker games that do not involve replication of held cards, as will be described in greater detail below.

Each of these other concurrently-played hands 310-320 are also dealt an initial hand, such as dealt poker cards 311 of poker hand-B 310, face down in one embodiment. In the present example, any cards that are held in poker hand-A 300, i.e. held card(s) 302, are replicated into the one or more poker hand-B 310 through poker hand-N 320. For example, held cards 302 from poker hand-A 300 are replicated into held cards 312 of poker hand-B 310. At this stage, in this example, the cards that were not held in poker hand-A 300 are discarded or otherwise unused, and exchanged for one or more replacement cards 303A. The held card(s) 302 and any replacement card(s) 303A then provide the final poker cards 304 to arrive at the resulting poker hand-A 300 that may be compared to a poker ranking to determine any awards.

In accordance with the present disclosure, the replacement cards 303A for a first, or original, or primary hand, poker hand-A 300 in this example, are replicated into one, more, or all of the other concurrently-played poker hands when the replacement card(s) 303A meet 306 some criteria. If the replacement cards 303A do not meet 306 the criteria, then in one embodiment replacement cards are obtained 308 normally at the respective poker hand, e.g., discarded cards at other hands 310, 320 are replaced from a deck(s) of cards for that poker hand. Thus, if the criteria is not met 306, the other concurrently-played poker hands (e.g., poker hand-B 310 through poker hand-N 320) are played as standard multi-play poker where their held cards are obtained from another poker hand (e.g., poker hand-A 300) and replacement cards are obtained as they normally would in a draw poker game. It should be recognized that any of the poker hands 300, 310, 320 may be used as the basis for determining whether the criteria is met, and need not be the first poker hand-A 300 in some embodiments.

On the other hand, if the criteria is met 306, the replacement card(s) 303A is/are replicated into one, more, or all, of the other poker hands 310, 320. This is depicted by the replacement card(s) 303A from the source hand(s) (poker hand-A 300 in this example) being replicated into replacement card(s) 303B of poker hand-B, and in the case of additional concurrently-played hands, then also optionally into one, more or all of the remaining concurrently-played hands through poker hand-N 320. In this manner, a criteria-meeting replacement card(s) 303A forming, for example, a certain final hand, or meeting a certain replacement card threshold can be “reused” in one or more other played poker hands. In one embodiment, if the replacement card(s) 303A meets 306 the criteria (whether dynamically determined or predetermined in various embodiments), then all of the other concurrently played hands 310, 320 will receive the same replacement cards 303B, etc. In other embodiments, some subset of the other poker hands 310, 320 will receive the replicated replacement cards, such as just the next successive poker hand 310, or a random one or more of the remaining hands 310, 320, etc.

Eligibility for the feature of allowing replacement/draw cards to be replicated into one or more other poker hands may be automatic based on the player's standard wager to participate in the gaming activity. In other embodiments, eligibility for such feature may be based on an additional wager, side bet, or other secondary action that may or may not involve additional player assets. In some embodiments, eligibility may be based on an award obtained by the player, a mystery bonus or other random event, longevity of play (e.g., after some time and/or number of plays, the player may be provided with eligibility in the feature), etc. Any manner of allowing the player access to the features described herein may be implemented, ranging from no additional action or player assets, to specific player action(s) and/or player asset(s).

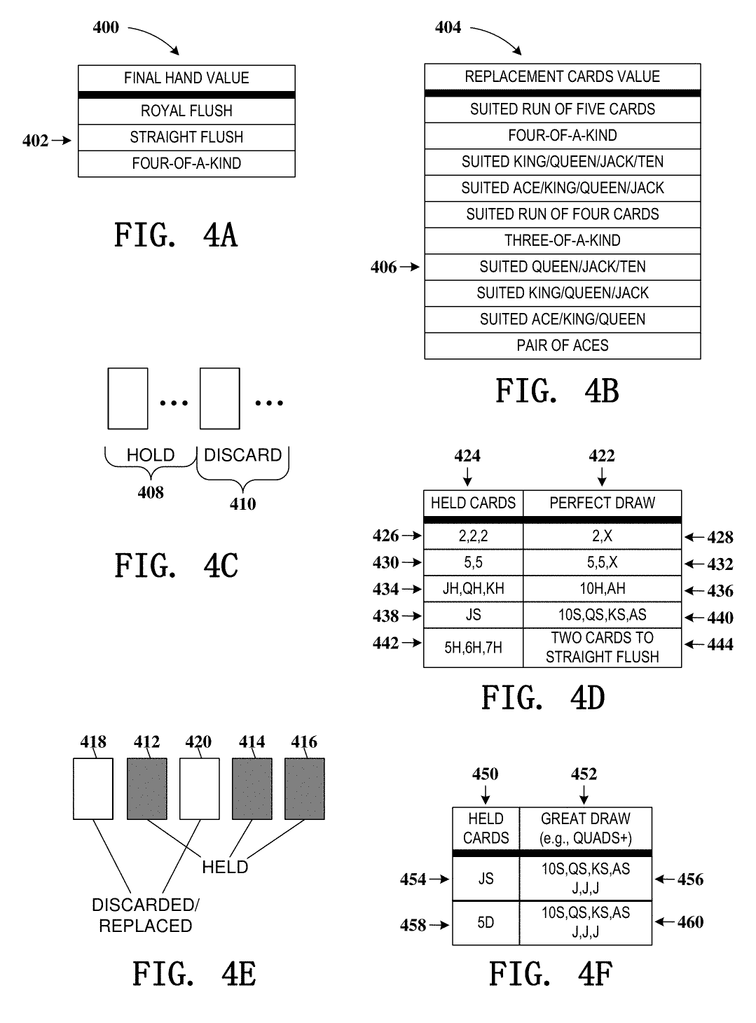

The criteria in which replacement cards are replicated into one or more other poker hands (versus those one or more other poker hands independently obtaining their own replacement/draw cards) may be established as desired for the particular game or situation. For example, the criteria may be based on a threshold poker rank of the final hand that is creatable based on the held cards and replaced cards (e.g., final hand results in four-of-a-kind or higher, or within a range of final hand results such as a full house through straight flush, etc.). FIG. 4A provides a representative example of poker rank criteria of the final hand value 400 for the first/original hand. In one embodiment, any of the criteria occurring in the final hand 400 will trigger those same replacement cards being replicated into all (or in some embodiments a subset of) the other poker hands that are being played. For example, if the final hand value 400 due to the particular replacement cards (together with the held cards that are replicated into the other concurrently-played hands) results in a straight flush 402, then the criteria is met and the same replacement cards are replicated into the other poker hands being played to result in additional straight flush final hands.

As another example, the criteria may be based on the poker rank, or individual or collective values, of the replacement cards themselves independent of the held cards (e.g., three or more of the same suit; three or more cards having the same value such as three Jacks; three or more cards being in a consecutive string such as a five, six, seven; etc.). An example is shown in FIG. 4B. For example, if the replacement cards result in a suited queen/jack/ten 406, this may be a predetermined three-card replacement rank that is automatically, or selectively by the user, used as the replacement cards in one, more or all of the other hands concurrently played.

In another example, the criteria is dynamic in that it is based at least in part on what the held cards are, where the criteria is whether the replacement cards result in perhaps the very best draw cards possible for the cards that are held, or are considered great draw cards (e.g., one of the top two or three possibilities) for the particular cards that are held, etc. For example, one or more cards may be held 408, and one or more cards discarded 410 (and subject to replacement) as depicted in FIG. 4C. Depending on what cards are held, there may be a perfect draw that would provide the best final poker hand possible in view of the held cards, which may also depend on how many cards are held. FIG. 4D depicts examples where a “perfect draw,” refers to drawing replacement cards that provide the best possible final hand result in a poker rank hierarchy, that is the criteria for the drawn cards to be replicated into other concurrently played hands.

As an example, if three cards are held 412, 414, 416 and two cards are discarded/replaced 418, 420 as shown in FIG. 4E, a “perfect draw” will depend on what the held cards are. FIG. 4D illustrates some representative replacement cards that would produce such a perfect/best draw 422 in view of certain held cards 424. For example, if the held cards 424 are three 2s 426, the best hand available with two replacement cards would be four-of-a-kind (also known as “quads”). Thus, a perfect draw 422 would include 2,X 428 (i.e. another 2 with “X” representing any other card), resulting in four of-a-kind in 2s. This “perfect draw” meets the criteria in this embodiment to cause replication of the drawn cards (i.e. a 2 card and any other card) into the other poker hands being played, which in a multi-play embodiment where held cards are replicated, would result in four-of-a-kind for each of the concurrently-played hands.

As another example, if the held cards 424 are two 5s 430, the best hand available with three replacement cards would be four-of-a-kind in 5s. Therefore, a perfect draw 422 would include 5,5,X 432 (i.e. two more 5s with “X” representing any other card), resulting in four of-a-kind in 5s. While other draw cards (such as one 5 card) would “improve” the resulting hand, the criteria in these examples are that the best or “perfect” draw occurs to provide the highest final hand possible in view of the held cards. Thus, a draw of two 5s would meet the criteria for replication into other played poker hands, while anything but at least two 5s being drawn would not meet the criteria, and replication of draw cards would not occur.

Another example includes held cards 424 of a Jack of Hearts (JH), Queen of Hearts (QH) and King of Hearts (KH) 434. In such case, the best draw cards would be a Ten of Hearts (10H) and Ace of Hearts (AH) 435, resulting in a royal flush. Another example includes single held card 424 of a Jack of Spades (JS) 438. While there are numerous combinations of draw cards that would potentially provide some winning payout, the top payout in this case may be a royal flush in most poker games, so the “perfect draw” 422 in such a case would include the Ten of Spades (10S), Queen of Spades (QS), King of Spades (KS) and Ace of Spades (AS) 444 to provide a royal flush.

In yet another example, the held cards 424 of a five, six and seven of hearts (5H, 6H, 7H) 442. The “best” result from these held cards would be a straight flush, In one embodiment, any cards leading to this would meet the criteria as a perfect draw 422, even though different cards may produce this result. For example, a 3 of Hearts (3H) and 4 of Hearts (4H) would meet the criteria for producing a 7-high straight flush, as would an 8 of Hearts (8H) and 9 of Hearts (9H) for producing a 9-high straight flush, as would a 4H and 8H for producing an 8-high straight flush. Thus, in such an embodiment, the criteria for a perfect draw 422 is two cards to a straight flush 444.

Other embodiments may not have criteria where a “perfect draw” is the threshold for replacement card replication into other concurrently-played draw poker hands, but rather a “very good draw” or “great draw” that may be defined as desired. For example, as shown in FIG. 4F, a single held card 450 of a Jack of Spades (JS) 454 could produce many final poker hand outcomes that would provide a payout, such as from a pair of Jacks all the way up to a royal flush. However, a threshold may be set, such as four-of-a-kind or higher (while in other embodiments less than some threshold such as less than a royal flush but greater than a flush). In the example of FIG. 4F, a threshold of four-of-a-kind or higher represents a defined “great draw” 452, which will serve as a triggering criteria to replicate such drawn cards from a first hand(s) into one, more or all of other concurrently-played poker hands. More particularly, if the held card is the JS 454, then the threshold of quads or higher provides at least two possible results, including a royal flush if the replacement cards 456 are a Ten of Spades (10S), Queen of Spades (QS), King of Spades (KS) and Ace of Spades (AS), and including four-of-a-kind if three more jacks are obtained on the draw. In one embodiment, the criteria is that either of these multiple possible outcomes occur, and if so, the particular set of replacement cards are replicated into the other concurrently-played hands. In another embodiment, the criteria is that a random selection between these multiple possible outcomes can meet the criteria for replication of the drawn cards into other hands (e.g., an indicator before or during dealing of replacement cards indicates whether quads or a royal flush will be the determinative criteria). Other criteria may analogously be established.

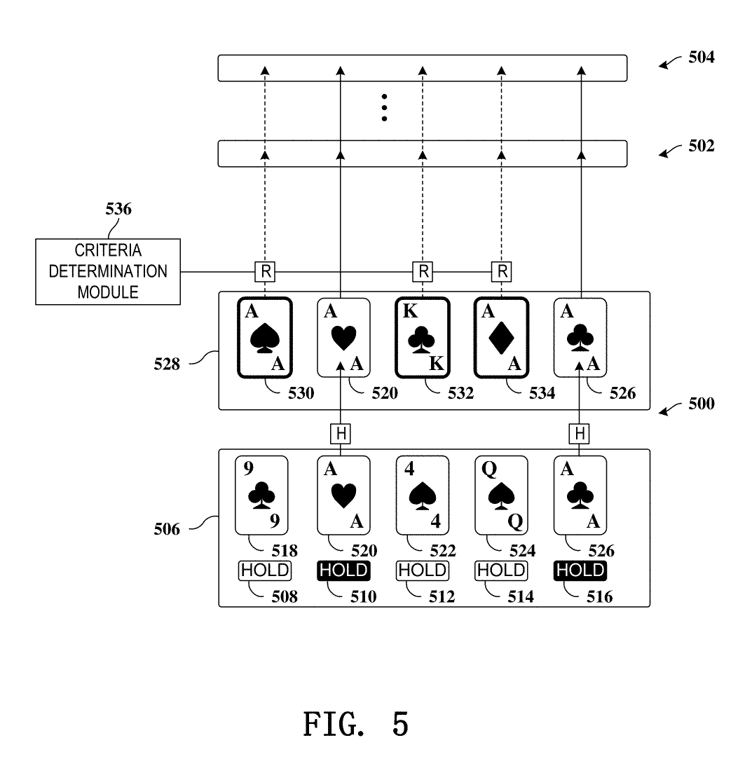

FIG. 5 depicts a representative example of a multi-hand draw poker game implementing an embodiment of a criteria-based draw card replication as disclosed herein. The example includes a plurality of concurrently-played draw poker hands, such as three hands 500, 502, 504. Initial deal 506 represents a first/original or “source” hand in a multi-play embodiment, where the player determines which cards to hold (if any) via hold user interface mechanisms 508, 510, 512, 514, 516, and those cards will be held (H) for the first hand 500 and other concurrently played hands 502, 504. In the example of FIG. 5, the initial deal 506 includes the 9 of Clubs 518, Ace of Hearts 520, 4 of Spades 522, Queen of Spades 524, and Ace of Clubs 526. The Ace of Hearts 520 and Ace of Clubs 526 have been held into the final hand 528, and due to the current multi-play example, are also held into all other concurrently-played hands 502-504.

As seen in the example of FIG. 5, cards 518, 522 and 524 were not held, and are therefore replaced in the final hand 528 with random draw cards, namely the Ace of Spades 530, King of Clubs 532, and Ace of Diamonds 534 in this example. Thus, the final hand received four-of-a-kind in Aces (cards 530, 520, 534, 526 from left to right in final hand 528). In accordance with one embodiment, some criteria or threshold may be met in which case those same drawn cards 530, 532 and 534 are replicated into one, more or all (all in this example) other concurrently-played hands 502-504. For example, if the criteria is a final hand of four-of-a-kind or higher, then the criteria determination module 536 (e.g., processor-based module) would determine that, and allow those replacement cards 530, 532, 534 to be replicated into the other hands 502-504. In another embodiment, if the criteria is at least a pair of Aces in the replacement cards, then the criteria determination module 536 would determine that, and allow those replacement cards 530, 532, 534 to be replicated into the other hands 502-504. In yet another embodiment, if the criteria is whether the replacement cards 530, 532, 534 created the best hand possible (or one of a plurality of best hands or high value hands possible) in view of the held cards 520, 526, then the criteria determination module 536 would determine that, and allow those replacement cards 530, 532, 534 to be replicated into the other hands 502-504. In this manner, a favorable draw of replacement cards is allowed to be used again in other hands 502-504 to provide even greater payouts.

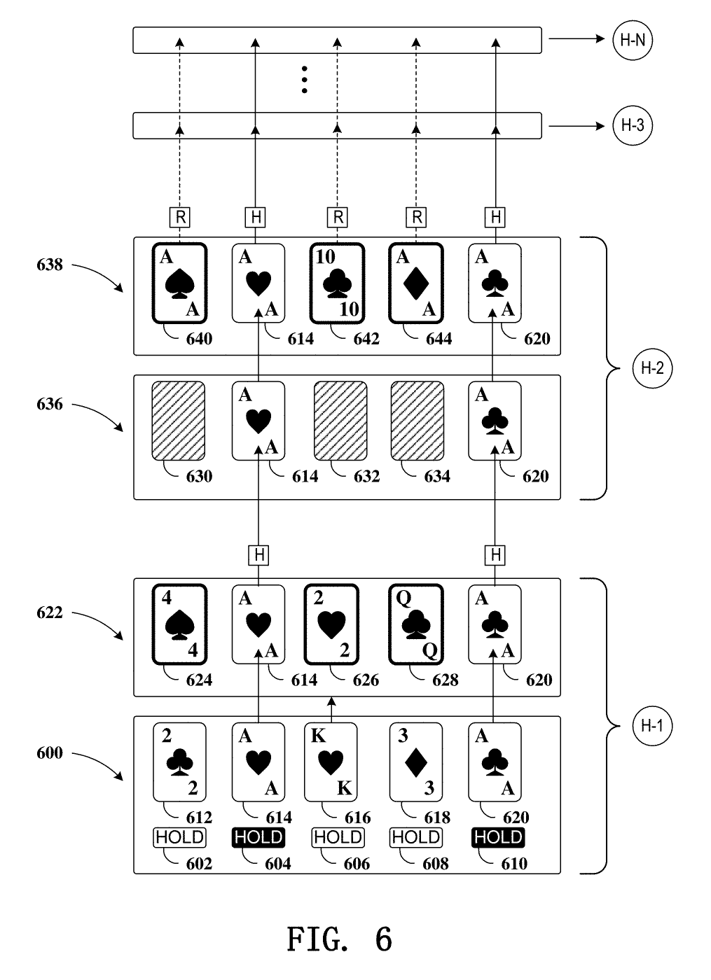

In another embodiment, hands of a multi-play draw poker game may be in some sequence, where replacement cards meeting certain criteria are allowed for use in hands subsequent to the hand meeting the criteria in the sequence. For example, in a multi-play poker game involving ten concurrently-played poker hands, the poker hands could be numbered 1-10. If the draw cards on hand number four, for example, met the criteria, the drawn cards in hand number four would be replicated into hands five through 10. FIG. 6 depicts an example of a multi-play poker game where replacement cards meeting certain criteria are allowed for use in hands subsequent to the hand meeting the criteria in the sequence.

In the example of FIG. 6, multiple hands are provided, where they are provided in some sequence, whether predetermined (e.g., numbered) or determined dynamically during play (e.g., taken in the order played by the player; randomly numbered; etc.). In this example, the hands are sequentially labeled hand-1 (H-1), hand-2 (H-2), hand-3 (H-3) through some finite number of hands labeled hand-N (H-N). The player first plays initial deal 600 of H-1, and determines which cards to hold (if any) via hold user interface mechanisms 602, 604, 606, 608, 610. Those held (H) cards will be held for the first hand H-1 and other concurrently played hands H-2, H-3, etc. In the example of FIG. 6, the initial deal 600 includes the Two of Clubs 612, Ace of Hearts 614, King of Hearts 616, Three of Diamonds 618 and Ace of Clubs 620. The Ace of Hearts 614 and Ace of Clubs 620 have been held into the final hand 622, and due to the current multi-play example, are also held into all other concurrently-played hands H-2 through H-N.

As seen in the example of FIG. 6, cards 612, 616 and 618 were not held, and are therefore replaced in the final hand 622 of H-1 with the Four of Spades 624, Two of Hearts 626 and Queen of Clubs 628. Therefore, the final hand 622 of H-1 results only in a pair of Aces, which in the present example is assumed to have not met the criteria to enable replication of replacement cards into subsequent hands of the sequence.

Play then moves onto the second hand, H-2, to obtain replacement/draw cards for the non-held cards 630, 632, 634 in the initial hand 636 of hand H-2. After normal replacement of non-held cards 630, 632, 634, new replacement cards are provided for the final hand 638 of H-2, including the Ace of Spades 640, Ten of Clubs 642, and Ace of Diamonds 644. This results in a final hand 638 of four-of-a-kind in Aces for H-2. Assuming that four-of-a-kind meets the criteria for draw card replication in this example, those same replacement cards 640, 642 and 644 are then replicated (R) into the remaining hands of the sequence H-3 through H-N. In this manner, a favorable draw of replacement cards is allowed to be used again in each of the hands H-3-H-N subsequent to the hand meeting the draw replication criteria to provide even greater payouts.

In another embodiment, rather than getting the replicated cards in the next/subsequent hands, replication cards and/or a resulting final hand that meets the criteria may enable the replacement cards to be substituted into all concurrently-played hands, whether already played or not. For example, assume the player plays a first hand of a multi-play draw poker game where the replacement cards did not meet the criteria, and therefore were not replicated into any other hands. Assume, however, that the replacement cards of the second hand met the criteria, in which case those replacement cards would be replicated into all subsequent hands, as well as replacing the replacement cards of the first hand (where the first hand could then be paid out on its first final hand 622 based on original replacement cards 624, 626, 628, or paid out on the replicated replacement cards from the second hand H-2, or paid out on both). In other words, in such an embodiment, obtaining replacement cards that meet the criteria in any of the hands causes all of the hands to get to use those advantageous replacement cards. In situations where multiple hands obtain different sets of replacement cards that meet the criteria, then rules may be used to select one of the sets of replacement cards, such as a rule indicating to use the set of replacement cards providing the highest poker rank and-or payout.

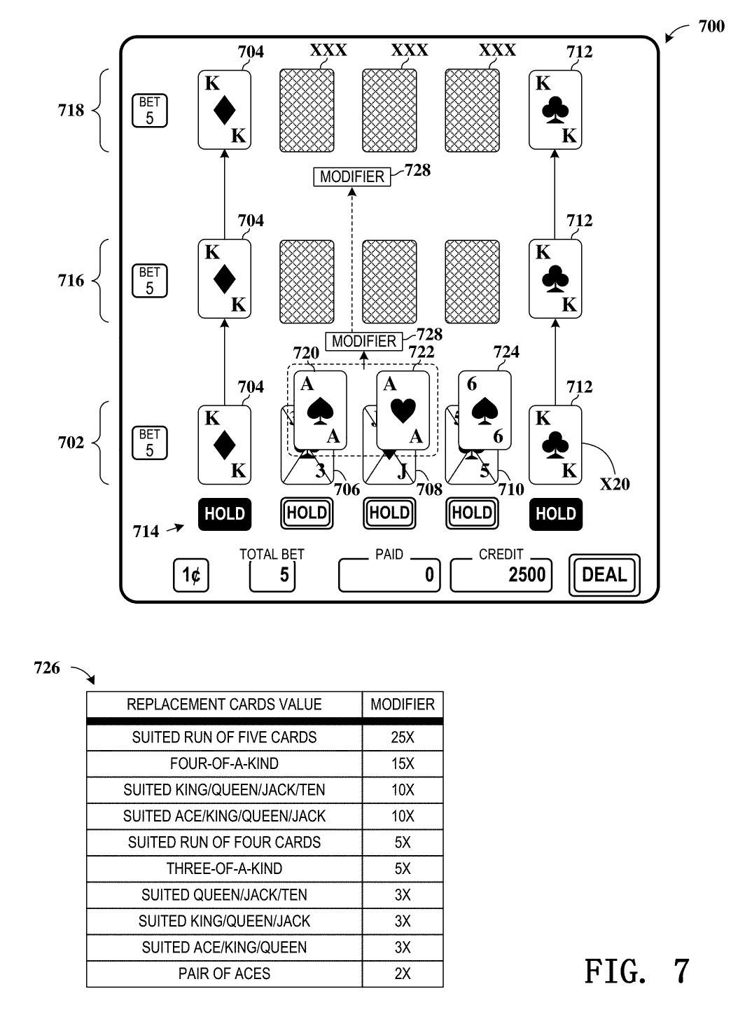

In yet another embodiment, different and the/or additional award enhancements may be provided when the draw cards meet the criteria. FIG. 7 depicts an example where a payout modifier, such as a multiplier, is provided for hands subsequent to the hand having draw cards triggering the feature. For example, FIG. 7 includes an electronic/video poker apparatus displaying a multi-hand poker game 700. The first hand 702 involves holding the King of Diamonds 704 and King of Clubs 712, and discarding the Three of Clubs 706, Jack of Diamonds 708, and Five of Spades 710 using the user interface 714 (e.g., HOLD and/or DISCARD buttons or other hardware and/or software selection interfaces). In this example, the held cards 704 and 712 are replicated into all other concurrently-played hands 716, 718.

In this example, the replacement cards for the first hand 702 include an Ace of Spades 720, Ace of Hearts 722, and Six of Spades 724. Assuming an embodiment where the state of the replacement cards themselves provide payout modifier values, such as depicted in the example of table 726, the next hand 716, or all hands 716, 718 (depending on the embodiment desired), can receive a modifier 728 based on those replacement cards, such as a 2× multiplier in the case of a pair of Aces. Thus, whatever the payouts on the other hands 716, 718, the modifier 728 may be used to increase any such payouts.

In still other embodiments, the modifier 728, if awarded on hands after the first hand, may also be applied to payouts from “prior” hands. Also, in some embodiments, the value of the modifier may be based on where in the sequence of poker hands the modifier was awarded. For example, if awarded on the first hand, the modifier may be a 5× multiplier, where if awarded on the second hand, the modifier may be a 3× multiplier, etc.

In other embodiments, providing a modifier 728 may be dependent on the final hand poker rank. For example, assume that the criteria to provide a modifier 728 to subsequent hands in a multi-play embodiment begins with a full house for a hand 702, where the modifier value increase as poker ranks increase above a full house. In the example of FIG. 7, the modifier would not be provided for failure to reach the established criteria, as the final hand value of hand 702 is two pair (Aces and Kings). However, had replacement cards 724 Ben another Ace, a final hand value for hand 702 would have been a full house, thereby meeting the criteria, and providing a modifier such as a multiplier to the next hand 716, or in other embodiments all remaining hands 716, 718 in the game.

In other embodiments, a modifier is provided only on the hand meeting the criteria, and the player gets to draw to any remaining hands. In one embodiment, replication of the draw cards into one or more other concurrently-played poker hands may remain available whether a multiplier or other modifier is also allowed for those hands or not.

In other embodiments, receiving a modifier on any hand will enable use of the modifier for all hands.

While many of the examples described herein involve replicating all of the replacement cards into other poker hands when the criteria has been met, other embodiments involve replication of any one of the replacement cards, or some portion of the replacement cards, which may be selected randomly, by predefined rules (e.g., certain suit and/or card values), etc.

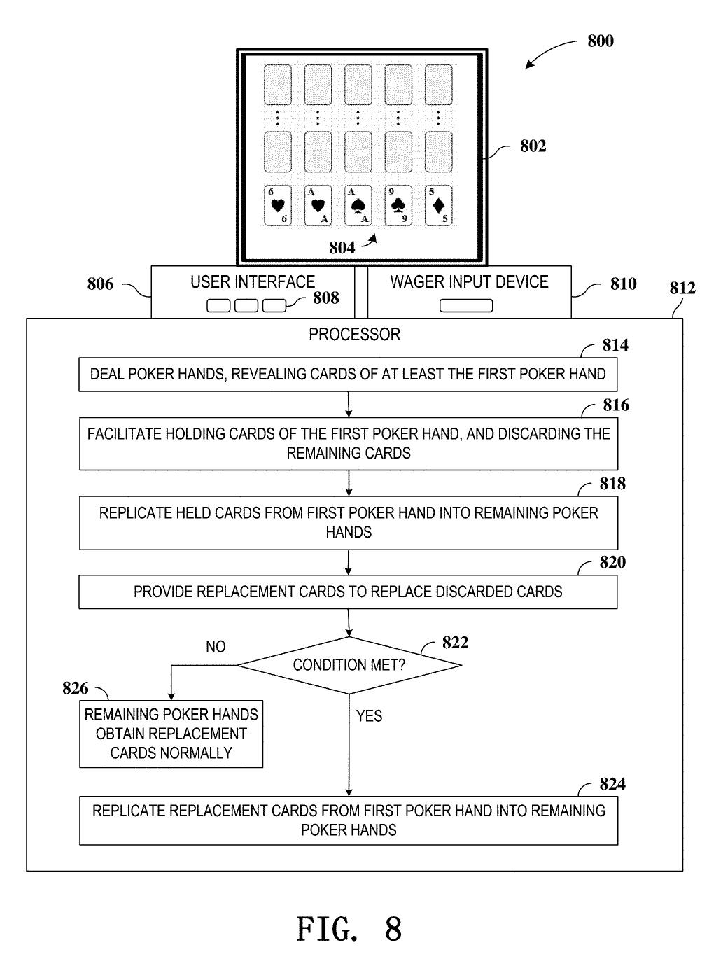

FIG. 8 is a block diagram of a representative gaming apparatus for completing poker hands based on activities in other poker hands. In the embodiment of FIG. 8, a poker device (e.g., video poker machine) 800 is provided on which players can play slot games. The representative poker device 800 includes at least a display(s) 8002 presenting a single or multiple poker hands 804. A user interface 806 is provided that includes at least one user input 808 to enable a player to initiate and participate in poker hands 804 presented via the display 802, and a wager input device 810 structured to identify and validate player assets and ultimately permit the player to play the poker game events when the player assets are provided. For purposes of illustration, the present example is described in terms of a multi-hand poker game, such as a triple-play poker game, where multiple poker hands are presented to the player at one time, and where cards held in one hand are replicated into all of the other concurrently-played hands.

A processor 812 is configured to, in one embodiment, deal 814 the plurality of poker hands and reveal cards of at least a first one of the plurality of poker hands. The processor 812 facilitates 816 holding any number of the cards of the first poker hand, and discarding those cards of the first poker hand that were not held. The cards held in the first poker hand are replicated 818 into the remaining poker hands. The processor further provides 820 replacement cards for the cards that were not held in the first poker hand, and determines 822 whether the replacement cards provided in the first hand meet a condition. If so, the replacement cards are replicated 824 into one or more of the remaining poker hands; else, the remaining poker hands obtain 826 their own random replacement cards in the normal fashion, e.g., randomly from the remaining cards of the deck(s).

Other embodiments involving a gaming apparatus such as that of FIG. 8 may involve variations of the processor-controlled modules. For example, the processor 812 may alternatively be configured to deal concurrently-played poker hands and reveal cards of (at least) a first one of the poker hands, facilitate holding any number of the cards of the first poker hand and discarding those cards of the first poker hand that were not held, and replicate the cards held in the first poker hand into the remaining poker hands in the sequence through the last poker hand. Such processor may be further configured to provide unique replacement cards for the first poker hand and each of the remaining poker hands along a sequence of the poker hands, until it is determined that a resulting poker hand value for one of the poker hands along the sequence meets a poker outcome condition, in which case the unique replacement cards from the poker hand that met the poker outcome condition are replicated into subsequent poker hands of the sequence.

Such a processor 812 may alternatively be configured to deal multiple poker hands, and to reveal cards of at least the first poker hand in the sequence. The processor enables holding any cards of the first poker hand, discarding of those cards that were not held, and replicating the held cards from the first poker hand into the remaining poker hands of the sequence. The processor may be further configured to provide first replacement cards for the first poker hand, and to determine whether a poker outcome of the first poker hand reaches a threshold poker value as a result of the first replacement cards. If so, in one embodiment, the first replacement cards are replicated into all, or a subset in some embodiments, subsequent poker hands in the sequence. If the first replacement cards of the first poker hand did not reach the threshold poker value, new replacement cards are provided for the next poker hand in the sequence.

The principles described herein are beneficial in many poker contexts, such as the multi-play poker contexts described herein, where cards are held and replicated into other concurrently-played hands, and where replacement cards meeting some criteria are replicated into one, more, or all of the other concurrently-played hands. However, the principles described herein are also applicable to single-hand poker games, where replacement cards may be replicated into hands of subsequent deals, i.e. where replacement cards persist across distinct poker events/deals. For example, if a single-hand play involves holding some cards, and drawing cards to provide a result that meets the replacement card replication criteria, then those replicated cards may be available for use to the player in a subsequently-played hand(s) on separate poker deals. In one embodiment, the player may be provided the option to use the replicated replacement cards from a prior poker event over what the player obtained via random replacement cards. For example, in a first gaming event (e.g., a first poker deal), the player may opt to hold two Aces, and discard the rest. If the player obtains two more Aces, for example, via the drawn cards in the draw poker game, the criteria may be met. In such case, the player may be afforded the option to use those two Aces obtained in the prior hand in a subsequent gaming event (e.g., a second poker deal), or to instead use the replacement cards obtained normally for that subsequent gaming event. The option to use such replacement cards from a prior hand may be provided for the next poker deal played, or for some number of consecutive subsequent poker deals, or for a random one or more subsequent poker deals, etc. Thus, it should be recognized that while many embodiments described herein are described in terms of a multi-hand poker game, the principles described herein are applicable to poker events that are not multi-hand, but rather are applied to other poker hands in subsequent poker deals.

In still other embodiments, the replication of replacement cards (whether a multi-hand play or across poker deals) may not replicate the exact replacement cards. For example, meeting the criteria to replicate replacement cards may trigger a special replacement card source, rather than replicating the exact cards. An example may be that where the held cards are an Ace and King of Spades, the next hand(s) receives a limited replacement card source that includes, for example, only Spades, and/or only Aces and Kings, etc. Such an embodiment may provide a higher probability of obtaining a favorable (or more favorable) outcome on subsequent hands, without precisely replicating the replacement cards. Thus, it should be recognized that replicating replacement cards in view of reaching the replacement card replication criteria may, in some embodiments, involve facilitating a better chance of obtaining a favorable/more favorable outcome on one or more other hands in a multi-hand poker game or across poker deals in a single-hand poker game.

The foregoing description of the representative embodiments has been presented for the purposes of illustration and description. It is not intended to be exhaustive or to limit the invention to the precise form disclosed. Many modifications and variations are possible in light of the above teaching. For example, the present invention is equally applicable in electronic or mechanical gaming machines, and is also applicable to live table versions of gaming activities that are capable of being played in a table version (e.g., machines involving poker or card games that could be played via table games).

Some embodiments have been described above, and in addition, some specific details are shown for purposes of illustrating the inventive principles. However, numerous other arrangements may be devised in accordance with the inventive principles of this patent disclosure. Further, well known processes have not been described in detail in order not to obscure the invention. Thus, while the invention is described in conjunction with the specific embodiments illustrated in the drawings, it is not limited to these embodiments or drawings. Rather, the invention covers alternatives, modifications, and equivalents that come within the scope and spirit of the principles set out herein and/or in the appended claims.

What is claimed is:

1. An apparatus for enhancing payouts in a multi-hand electronic poker event, comprising:
a display presenting the multi-hand electronic poker event and an associated plurality of poker hands;
a user interface including at least one user input to enable a player to initiate play in the multi-hand electronic poker event;
a wager input device structured to identify and validate player assets, and to permit the player to play the multi-hand electronic poker event when the player assets are provided; and
a processor configured to:
deal the plurality of poker hands, and reveal cards of at least a first one of the plurality of poker hands;
facilitate holding any number of the cards of the first poker hand, and discarding those cards of the first poker hand that were not held;
replicate the cards held in the first poker hand into the remaining ones of the plurality of poker hands;
provide replacement cards for the cards that were not held in the first poker hand;
determine whether the replacement cards provided in the first hand meet a condition; and
replicate the replacement cards into one or more of the remaining ones of the plurality of poker hands if the condition is met.

2. The apparatus of claim 1, wherein the processor is configured to replicate the replacement cards into all of the remaining ones of the plurality of poker hands in response to the condition being met.

3. The apparatus of claim 1, wherein the processor is configured to determine whether the replacement cards provided in the first hand meet the condition by determining whether the replacement cards cause a result of the first hand to reach a threshold poker hand value.

4. The apparatus of claim 3, wherein the condition comprises the cards required to provide the highest ranking result possible given the cards held in the first poker hand, and wherein the processor is configured to determine whether the replacement cards provided in the first hand correspond to the cards required to provide the highest ranking result possible.

5. The apparatus of claim 3, wherein the processor is configured to determine whether the replacement cards cause the result of the first hand to reach the threshold poker hand value by determining whether the result of the first hand includes a predetermined number of like card values.

6. The apparatus of claim 3, wherein the processor is configured to determine whether the replacement cards cause the result of the first hand to reach the threshold poker hand value by determining whether the result of the first hand includes a consecutive string of card values.

7. The apparatus of claim 3, wherein the processor is configured to determine whether the replacement cards cause the result of the first hand to reach the threshold poker hand value by determining whether the result of the first hand includes all cards having a common card suit.

8. The apparatus of claim 3, wherein the processor is configured to determine whether the replacement cards cause the result of the first hand to reach the threshold poker hand value by determining whether the result of the first hand includes a consecutive string of card values having a common card suit.

9. The apparatus of claim 3, wherein the processor is configured to determine whether the result of the first hand reaches the threshold poker value by comparing the result of the first hand to one or more predetermined poker hand values that meet or exceed the threshold poker hand value.

10. The apparatus of claim 1, wherein the processor is configured to determine whether the replacement cards provided in the first hand meet a condition by comparing the replacement cards to a plurality of predetermined poker values that meet or exceed threshold card values.

11. A gaming device, comprising:
a display presenting a poker event involving a plurality of concurrently-played poker hands presented in a sequence ranging from a first poker hand to a last poker hand;
a user interface including at least one user input to enable a player to initiate play in the poker event;
a wager input device structured to identify and validate player assets, and to permit the player to play the poker event when the player assets are provided; and
a processor configured to:
deal the plurality of concurrently-played poker hands, and reveal cards of at least a first one of the poker hands;
facilitate holding any number of the cards of the first poker hand, and discarding those cards of the first poker hand that were not held;
replicate the cards held in the first poker hand into the remaining ones of the plurality of poker hands in the sequence through the last poker hand;
provide unique replacement cards for the first poker hand and each of the remaining ones of the plurality of poker hands along the sequence, until it is determined that a resulting poker hand value for one of the poker hands along the sequence meets a poker outcome condition; and
replicate the unique replacement cards from the poker hand that met the poker outcome condition into subsequent poker hands of the sequence.

12. The gaming device of claim 11, wherein the processor is further configured to replicate the unique replacement cards, from the poker hand that met the poker outcome condition, into prior poker hands of the sequence, before the resulting poker hand values for those prior poker hands of the sequence are established for win analysis.

13. The gaming device of claim 11, wherein the processor is further configured to replicate the unique replacement cards, from the poker hand that met the poker outcome condition, into prior poker hands of the sequence, after the resulting poker hand values for those prior poker hands of the sequence have already been established for win analysis to provide for a second win analysis.

14. The gaming device of claim 11, wherein the poker hand along the sequence that meets the poker outcome condition is any of the poker hands in the sequence.

15. The gaming device of claim 11, wherein the processor is further configured to apply a payout modifier to the resulting poker hand value for the poker hand that met the poker outcome condition.

16. The gaming device of claim 15, wherein the processor is further configured to establish a value of the payout modifier based at least in part upon which poker hand in the sequence the poker outcome condition was met.

17. The gaming device of claim 16, wherein the processor is configured to establish the value of the payout modifier to be higher the earlier in the sequence that the poker outcome condition was met.

18. The gaming device of claim 15, wherein the processor is further configured to apply the payout modifier to the resulting poker hand values for the subsequent poker hands of the sequence.

19. A gaming device, comprising:
a display presenting a poker event involving a plurality of poker hands arranged in a sequence beginning with a first poker hand;
a user interface including at least one user input to enable a player to initiate play in the poker event;
a wager input device structured to identify and validate player assets, and to permit the player to play the poker event when the player assets are provided; and
a processor configured to:
deal the plurality of poker hands, and reveal cards of at least the first poker hand in the sequence;
facilitate holding any number of the cards of the first poker hand, and discarding those cards of the first poker hand that were not held;
replicate the cards held in the first poker hand into the remaining ones of the plurality of poker hands;
provide first replacement cards for the first poker hand;
determine whether a poker outcome of the first poker hand reaches a threshold poker value as a result of the first replacement cards;
replicate the first replacement cards into all subsequent ones of the plurality of poker hands in the sequence if the poker outcome of the first poker hand reached the threshold poker value; and
provide new replacement cards for the next one of the poker hands in the sequence if the first replacement cards of the first poker hand did not reach the threshold poker value.

20. The gaming device of claim 19, wherein the processor is configured to determine the best poker hand possible given the cards held in the first poker hand, and to set the threshold poker value to that best poker hand possible for the poker event.
